(19) United States
(12) Patent Application Publication
(10) Pub. No.: US 2024/0422004 A1
(43) Pub. Date: Dec. 19, 2024

(54) RECONCILIATION OF TRANSACTIONS IN MESSAGING SYSTEMS USING CRYPTOGRAPHY ALGORITHMS

(71) Applicant: INTERNATIONAL BUSINESS MACHINES CORPORATION, Armonk, NY (US)

(72) Inventors: OMPRAKASH RAMAVADH UPADHYAY, Dallas, TX (US); Mudit Mehrotra, Bengaluru (IN)

(21) Appl. No.: 18/210,908

(22) Filed: Jun. 16, 2023

(51) Int. Cl. H04L 9/32

(52) U.S. Cl. CPC H04L 9/3236

(57) ABSTRACT

A system, method, and computer program product are configured to: receive a message at a first data center, wherein the message includes a payload and is associated with a transaction; create a correlation identifier for the message using an encryption process with the payload of the message; replicate the message and the correlation identifier at a second data center, wherein the replicated message includes a copy of the payload in a work-in-progress queue of the second data center; and in response to a failure of the first data center and a processing of the transaction using the replicated message at the second data center, reconcile the transaction using the correlation identifier.

### BACKGROUND

Aspects of the present invention relate generally to messaging systems and, more particularly, to reconciliation of transactions in messaging systems using cryptography algorithms.

Messaging systems may include message-oriented middleware (MOM), also called MOM-based middleware, that allows distributed applications to communicate and exchange data by sending and receiving messages. Applications communicate by sending each other data in messages rather than by calling each other directly.

### SUMMARY

In a first aspect of the invention, there is a computer-implemented method including: receiving a message at a first data center, wherein the message includes a payload and is associated with a transaction; creating a correlation identifier for the message using an encryption process with the payload of the message; replicating the message and the correlation identifier at a second data center, wherein the replicated message comprises a copy of the payload in a work-in-progress queue of the second data center; and in response to a failure of the first data center and a processing of the transaction using the replicated message at the second data center, reconciling the transaction using the correlation identifier.

In another aspect of the invention, there is a computer program product including one or more computer readable storage media having program instructions collectively stored on the one or more computer readable storage media. The program instructions are executable to: receive a message at a first data center, wherein the message includes a payload and is associated with a transaction; create a correlation identifier for the message using an encryption process with the payload of the message; replicate the message and the correlation identifier at a second data center, wherein the replicated message comprises a copy of the payload in a work-in-progress queue of the second data center; and in response to a failure of the first data center and a processing of the transaction using the replicated message at the second data center, reconcile the transaction using the correlation identifier.

In another aspect of the invention, there is a system including a processor set, one or more computer readable storage media, and program instructions collectively stored on the one or more computer readable storage media. The program instructions are executable to: receive a message at a first data center, wherein the message includes a payload and is associated with a transaction; create a correlation identifier for the message using an encryption process with the payload of the message; replicate the message and the correlation identifier at a second data center, wherein the replicated message comprises a copy of the payload in a work-in-progress queue of the second data center; and in response to a failure of the first data center and a processing of the transaction using the replicated message at the second data center, reconcile the transaction using the correlation identifier.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

### DETAILED DESCRIPTION

Aspects of the present invention relate generally to messaging systems and, more particularly, to reconciliation of transactions in messaging systems using cryptography algorithms. Message queue messaging systems operate by placing messages on queues, so that programs can run independently of each other, at different speeds and times, in different locations, and without having a direct connection between them. In such systems, applications communicate by sending messages to a queue and receive messages from a queue rather than by calling each other directly. Queue managers implemented in message-oriented middleware are where messaging resources, such as queues, are configured and what applications connect to, either running on the same system as the queue manager or over the network. A network of connected queue managers supports asynchronous routing of messages between systems, where producing and consuming applications are connected to different queue managers.

Messages in a queue at one site are replicated to one or more queues at different sites to provide for disaster recovery. For example, when a first site fails, replicated messages at a second site may be used to reconcile and settle transactions that were interrupted due to failure of the first site. Doing so, however, is problematic because it is a manually intensive process. Many organizations spend huge amounts of time manually settling business transactions when there is a complete fail-over of an application or site zone failure to another application site zone. The fail-over condition may arise due to uncontrolled network failure, operating system (OS) failure, hardware failure, or disaster recovery (DR) drill, for example. The availability and processing of time-bound and business-critical transactions across application site zones are needed by many organizations, especially financial institutions.

A message queue messaging system generates unique a message identifier for each message received. The message identifier is of a certain length with its attached payload. The message identifier consists of a product identifier followed by a product-specific implementation of a unique string, for example the first 12 characters of the queue manager name and a value derived from the system clock. The payload can be the same or different for the transaction leading to a risk of duplication of the transaction, which is an undesired result. For example, it is important for a financial transaction that no duplicate message is transported which would otherwise lead to transaction rollback and reconciliation. The complexity of reconciliation becomes difficult using the messaging system itself as the payload is encrypted and because the message identifiers are different while replicating messages from one site to another (e.g., from one data center to another). Since the message identifiers are unique for each message, the reconciliation mechanism is done manually with respect to records updated in a database after consumption of a message. This process is time consuming and difficult for the system reconciliation during the site switch over from a first site to a second site. Therefore, there exists a need to automate the reconciliation of transactions in a message queue messaging system when a site fails.

Implementations of the invention address this need by providing a method for reconciliation of transactions in messaging systems using cryptography algorithms. In embodiments, the method includes: receiving a message at a first data center, wherein the message includes a payload and is associated with a transaction; creating a correlation identifier for the message using an encryption process with the payload of the message; replicating the message and the correlation identifier to a second data center, wherein the replicated message comprises a copy of the payload and the correlation identifier in a work-in-progress queue of the second data center; and in response to a failure of the first data center, reconciling the transaction using the correlation identifier of the replicated message in the work-in-progress queue of the second data center. In this manner, implementations of the method achieve message availability, processing, and settlement of unprocessed messages across application sites during application site zone fail-over.

Implementations of the invention achieve automated reconciliation by using data in the message-oriented middleware (e.g., a novel correlation identifier) instead of data at rest in a database. In embodiments, a tiger cryptographic iterated hash is applied on a payload of a message to generate a 24-byte long code referred to herein a correlation identifier. The correlation identifier is different from and in addition to the message identifier in that the correlation identifier is generated based on the message payload and also in that the correlation identifier is copied with the message payload when a message is replicated from the queue of one site to the queue of another site in the message-oriented middleware. In embodiments, the correlation identifier is matched for reconciliation in the case of a message queue message for a transaction across applications with different sites, and the reconciliation process becomes automatic with the generated code. In this manner, the correlation identifier may be used for determining the integrity of replicated messages. Implementations provide a benefit of making the reconciliation completely automated and ensuring zero error, thus making the message queue messaging system fault tolerant. This automatic reconciliation of a message queue messaging system transaction reduces the time for reconciliation compared to the current manual techniques. Such time reduction can be from a matter of days when performed manually to a matter of minutes when performed in an automated manner as described herein.

In embodiments, the correlation identifier generated using the tiger hash algorithm also helps in overcoming duplicate transaction issues in such systems by comparing correlation identifiers and rejecting a message before processing the transaction associated with the message. In embodiments, the message-oriented middleware automatically matches the correlation identifier stored in the messaging system with the incoming message. If a match is found for the correlation identifier with the incoming message, then the message is rejected as being a duplicate. On the other hand, if no match exists, then the incoming message is accepted as not being a duplicate. Implementations thus drastically reduce the time taken for reconciliation of transactions in the message queue messaging system. In addition, implementations provide a mechanism introduced to perform self-validation and correction in the messaging system to further enhance quality of service and reliability.

Implementations of the invention provide an advantage over systems that use a database to address the problem of duplicate massages and transactions. Systems that use a databases require an additional component (i.e., the database itself) to store information for comparison. This adds the overhead of deploying and maintaining the database, and also has the drawback of requiring additional operations to store data in and retrieve data from the database when comparing incoming messages for duplicates. These additional operations require additional time and processing power compared to embodiments described herein. Implementations of the invention thus provide an advantage over database-based systems in terms of less required infrastructure and lower processing power needs.

In accordance with aspects of the invention, there is a method for managing an electronic messaging system associated with MOM (message-oriented middleware), comprising: creating a correlation identifier by an encryption process, wherein the encryption process is a tiger cryptographic iterated hash; storing a copy of the correlation identifier by the electronic messaging system; attaching the correlation identifier to data payload associated with the electronic messaging system; sending the data payload with the attached correlation identifier between a plurality of data application systems, wherein the data systems comprises of DCs (data centers) and DRs (data recovery); receiving the data payload; processing the correlation identifier attached to the data payload by matching the correlation identifier to the copy of the correlation identifier already stored within the electronic messaging system; in responsive to the correlation identifier does not match the copy of the correlation identifier, accepting the data payload; and in responsive to the correlation identifier does match the copy of the correlation id, rejecting the data payload. In embodiments, the correlation identifier is a 24-byte code.

Implementations of the invention are necessarily rooted in computer technology. For example, operations performed by message-oriented middleware are necessarily performed by a computer since message-oriented middleware by definition comprises middleware that resides between different layers of a distributed computing system. Furthermore, creating a correlation identifier using a hashing algorithm also cannot be performed in the human mind or with pen and paper.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as reconciliation code at block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

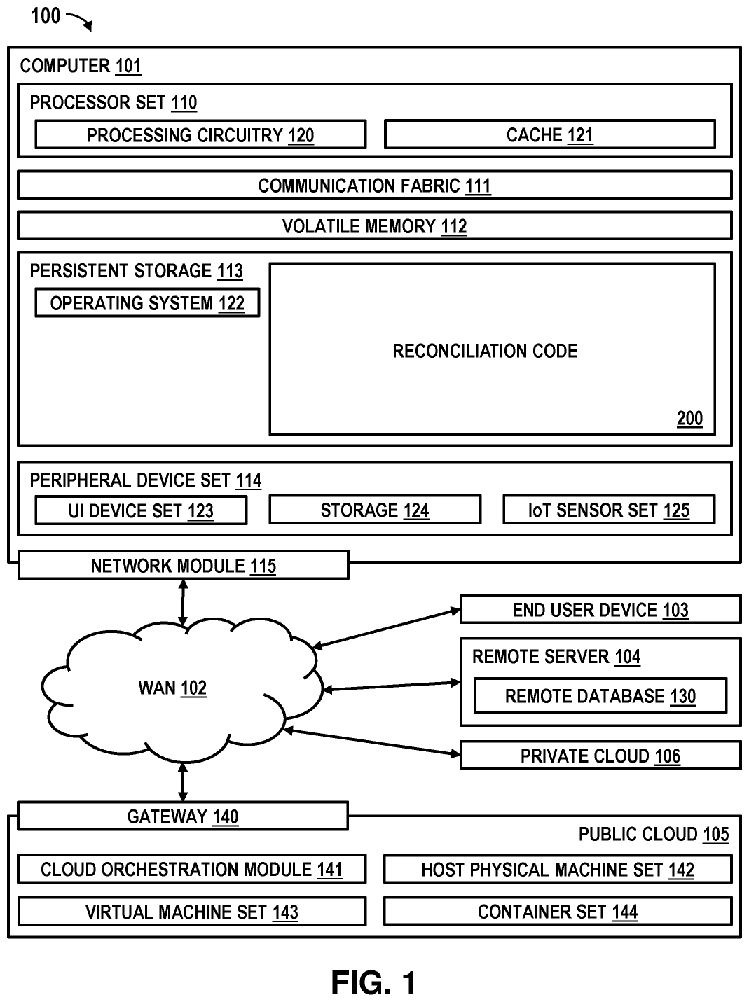

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

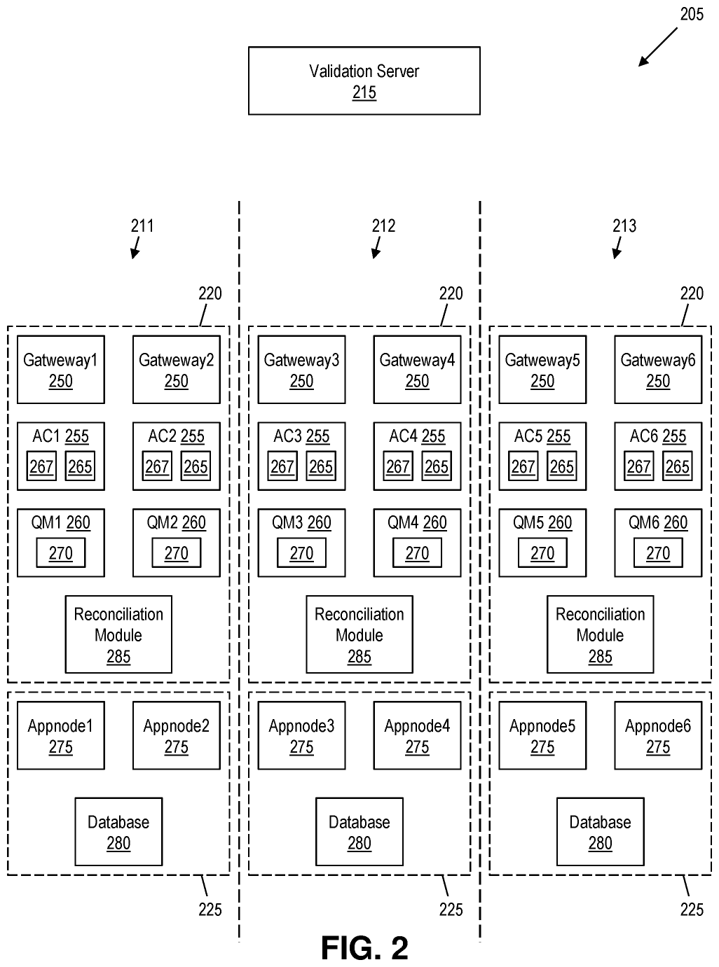

FIG. 2 shows a block diagram of an exemplary environment 205 in accordance with aspects of the invention. In embodiments, the environment includes a plurality of sites 211, 212, and 213. The sites 211-213 may comprise respective data centers at different geographic locations, such as Mumbai, London, and New York, for example. Each of the sites 211-213 comprises a middleware layer 220 and an application layer 225. The environment 205 may also include a validation server 215 centrally located relative to the sites 211-213, for example in the cloud.

In embodiments, the middleware layer 220 of a site comprises a gateway 250, an app connect module 255, and a queue manager 260. There may be plural instances of the gateway 250, app connect module 255, and queue manager 260 at each site 211-213. In embodiments, the gateway 250 sends messages from and receives messages into a site. The gateway 250 bridges various messaging and transport protocols. In embodiments, the app connect module 255 provides separate connectors for use in the cloud and containerized environments. The app connect module 255 can connect to a number of supported queue managers 260 and perform operations such as obtaining an incoming message from the gateway 250, storing the message in a work-in-progress queue 265, and replicating the message to other sites. The app connect module 255 may also include a clash queue 267. In embodiments, the queue manager 260 manages send queues and receive queues (both represented collectively at number 270) at a site. In embodiments, the queue manager 260 provides a message to an application node 275 that contains an application that performs a transaction based on the message. For example, in a banking implementation, the application may perform a banking transaction based on the message. In embodiments, the application node 275 is in the application layer 225, i.e., not in the middleware layer 220. In embodiments, a data center may include a database 280 that stores data at rest for the site.

In the example shown in FIG. 2, each site 211-213 includes two instances of the gateway 250, app connect module 255, queue manager 260, and application node 275, labeled Gateway1-6, AC1-6, QM1-6, and Appnode1-6, respectively. Implementations are not limited to the configuration shown in FIG. 2, and other numbers of sites and components within each site may be used.

In accordance with aspects of the invention, the middleware layer 220 of each site 211-213 includes a reconciliation module 285, which may comprise one or more modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The middleware layer 260 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In an example of normal processing of a message and transaction in the environment 205, a gateway 250 (e.g., Gateway1) of site 211 receives a message from an external application or system (not shown). A message received at a gateway is referred to as a gateway message. In this example, the app connect node 255 (e.g., AC1) of a primary site (e.g., site 211) obtains the message from the gateway 250 (e.g., Gateway1) and replicates the message to app connect nodes 255 (e.g., AC3 and AC5) at different sites 212 and 213. The app connect node 255 (e.g., AC1) of the first site 211 stores the message in it work-in-progress queue 265. The app connect nodes 255 (e.g., AC3 and AC5) of the other sites 212 and 213 store the replicated message in their respective work-in-progress queues 265. In this example, the queue manager 260 (e.g., QM1) of the first site 211 provides the message to the application node 275 (e.g., Appnode1). An application running on the application node 275 (e.g., Appnode1) successfully consumes the message by performing a transaction using the message and then generates an acknowledgement message indicating that this message was successfully consumed. The acknowledgement message is passed to the middleware layer 220 of the first site 211, which passes the acknowledgement message to the middleware layer 220 of each of the second and third sites 212 and 213. Based on receiving the acknowledgement message, the middleware layer 220 of each site 211-213 removes (e.g., deletes) the message from the respective work-in-progress queues 265 of the respective app connect nodes 255 (e.g., AC1, AC3, and AC5). This example of normal processing occurs when the primary site (e.g., the first site 211) functions normally and does not experience a failure that renders it unable to process the message and transaction.

In conventional systems, if a primary site experiences a failure that renders it unable to process the message and transaction, then one of the other sites may be used to complete the transaction using the replicated message. Then, when the primary site is operational again, the message and transaction are reconciled using records stored in databases (e.g., static data). This provides the messaging system with disaster recovery. However, current systems involve a large amount of manual intervention to achieve this. The complexity of reconciliation becomes difficult using the messaging system since the payload is encrypted and because the message identifiers are different while replicating messages from one site to another (e.g., from one data center to another). Since the message identifiers are unique for each message, the reconciliation mechanism done is manually with respect to records updated in a database after consumption of a message. This process is time consuming and difficult for the system reconciliation during the site switch over from a first site to a second site. Implementations of the invention automate the reconciliation using a novel correlation identifier.

In accordance with aspects of the invention, the validation server 215 receives individual confirmation from each site that replicates a message. In embodiments, the validation server 215 works in a high-availability (HA) mode. In embodiments, the validation server 215 maintains a repository which holds related data of which sites are sending an acknowledgement and a number of times this is not being received from others. In embodiments, based on the gateway message being successfully consumed by the receiving application at the primary site, the receiving application generates the acknowledgement message as described above. In embodiments, in response to receiving the acknowledgement message, the middleware layer 220 at the primary site removes the message from its work-in-progress queue and sends a removal message to each of the sites that confirmed replication. In embodiments, in response to receiving the acknowledgement message, the middleware layer 220 at the secondary sites removes the replicated message from their respective work-in-progress queues. In embodiments, the removal message is only sent to the secondary sites that confirmed replication to the validation server 215. This ensures no redundant delete requests are going to applications which did not receive the original packet thus reducing load on system and unnecessary chances of error. Additionally, this also provides an ongoing system of data collection on resilience for the overall system which may be analyzed and utilized for compliance and upgrades.

In accordance with aspects of the invention, if the primary site (e.g., site 211) suffers a failure that makes it unavailable, then the replicated message is processed at one of the secondary sites (e.g., sites 212 and 213). In embodiments, a receiving application at an application node of the second site (e.g., Appnode3) consumes the replicated message and generates an acknowledgement message for the successful processing of the message. In embodiments, upon receipt of the acknowledgement message from the application that processed the message, the middleware layer 220 of the second site 212 reconciles the message with the middleware layer 220 of the third site 213. This reconciliation removes the replicated message from the work-in-progress queue of all currently available sites (e.g., the second site 212 and the third site 213 in this example). In embodiments, when the primary site (e.g., site 211 in this example) becomes available again, the middle ware layer 220 of the site that process the message (e.g., site 212 in this example) reconciles the message with the middleware layer 220 of the primary site. This reconciliation removes the message from the work-in-progress queue of the primary site so that the message is not reprocessed. In accordance with aspects of the invention, these reconciliations are performed using the novel correlation identifier that is generated when the message is first received at the primary site. In embodiments, when the app connect node 255 of the primary site obtains the message from the gateway of the primary site, the reconciliation module 285 of the primary site creates the unique correlation identifier for this message by applying a hashing algorithm to the payload of the message. In embodiments, this correlation identifier is transmitted with the message when a message is replicated at a secondary site or is created at the secondary site by applying the same hashing algorithm to the payload of the replicated message. Because the payload of the replicated message is the same as the payload of the original message at the primary site, applying the same hashing algorithm will create the same unique correlation identifier. In this manner, a common yet unique correlation identifier can be created for a message at the primary site and the replicated versions of this same message at the secondary sites. In embodiments, this correlation identifier is used to identify the same message payload in different work-in-progress queues during reconciliation, thereby allowing the middleware to remove messages automatically based on the correlation identifier.

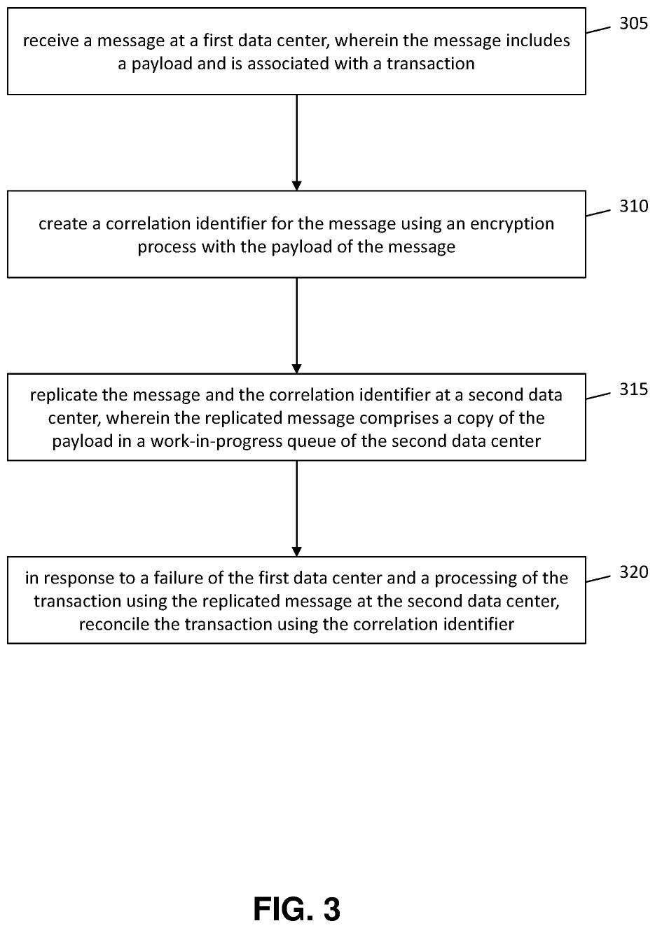

FIG. 3 shows a flowchart of an exemplary method in accordance with aspects of the present invention. Steps of the method may be carried out in the environment of FIG. 2 and are described with reference to elements depicted in FIG. 2.

At step 305, the system receives a message at a first data center, wherein the message includes a payload and is associated with a transaction. In embodiments, and as described with respect to FIG. 2, a gateway of a primary site receives a message. In embodiments, the gateway is comprised in a middle ware layer that places the message in a work-in-progress queue of an app connect module.

At step 310, the system creates a correlation identifier for the message using an encryption process with the payload of the message. In embodiments, and as described with respect to FIG. 2, the reconciliation module creates the correlation identifier by applying a hashing algorithm to the payload of the message.

At step 315, the system replicates the message and the correlation identifier at a second data center, wherein the replicated message comprises a copy of the payload in a work-in-progress queue of the second data center. In embodiments, and as described with respect to FIG. 2, the middleware layer of the primary site sends a copy of the message payload to the middleware layer of a secondary site. The secondary site either receives the correlation identifier with the copy of the payload or recreates the same correlation identifier by applying the same hashing algorithm to the payload.

At step 320, in response to a failure of the first data center and a processing of the transaction using the replicated message at the second data center, the system reconciles the transaction using the correlation identifier. In embodiments, and as described with respect to FIG. 2, if the primary site fails, then the replicated message is consumed by an application at one of the secondary sites, thereby processing (e.g., completing) the transaction. In this situation, the replicated messages in the work-in-progress queues at all available second sites are removed based on them all having the correlation identifier. In this situation, when the primary site becomes available again, the message in the work-in-progress queue of the primary site is removed based on it having the same correlation identifier.

In embodiments of the method, the encryption process comprises applying a tiger cryptographic iterated hashing algorithm to the payload. In embodiments of the method, the applying the tiger cryptographic iterated hashing algorithm to the payload generates a 24-byte code.

In embodiments of the method, the message is received at a gateway of the first data center, the message is placed in a work-in-progress queue in the first data center, and the gateway of the first data center, the work-in-progress queue in the first data center, and the work-in-progress queue of the second data center are comprised in a message-oriented middleware messaging system. In embodiments, the method further comprises storing the correlation identifier in the message-oriented middleware messaging system. In embodiments, the method further comprises avoiding duplicating the transaction using the correlation identifier by comparing the correlation identifier stored in the message-oriented middleware messaging system to a correlation identifier of an incoming message. In embodiments, the avoiding duplicating the transaction comprises: rejecting the incoming message as a duplicate based on the correlation identifier stored in the message-oriented middleware messaging system matching the correlation identifier of the incoming message; and accepting the incoming message based on the correlation identifier stored in the message-oriented middleware messaging system not matching the correlation identifier of the incoming message. In embodiments, the reconciling the transaction comprises removing the message from the work-in-progress queue in the first data center and removing the replicated message from the work-in-progress queue in the second data center based on the correlation identifier.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, a message at a first data center, wherein the message includes a payload and is associated with a transaction;
creating, by the processor set, a correlation identifier for the message using an encryption process with the payload of the message;
replicating, by the processor set, the message and the correlation identifier at a second data center, wherein the replicated message comprises a copy of the payload in a work-in-progress queue of the second data center; and
in response to a failure of the first data center and a processing of the transaction using the replicated message at the second data center, reconciling, by the processor set, the transaction using the correlation identifier.

2. The computer-implemented method of claim 1, wherein the encryption process comprises applying a tiger cryptographic iterated hashing algorithm to the payload.

3. The computer-implemented method of claim 2, wherein the applying the tiger cryptographic iterated hashing algorithm to the payload generates a 24-byte code.

4. The computer-implemented method of claim 1, wherein:
the message is received at a gateway of the first data center;
the message is placed in a work-in-progress queue in the first data center; and
the gateway of the first data center, the work-in-progress queue in the first data center, and the work-in-progress queue of the second data center are comprised in a message-oriented middleware messaging system.

5. The computer-implemented method of claim 4, further comprising storing the correlation identifier in the message-oriented middleware messaging system.

6. The computer-implemented method of claim 5, further comprising avoiding duplicating the transaction by comparing the correlation identifier stored in the message-oriented middleware messaging system to a correlation identifier of an incoming message.

7. The computer-implemented method of claim 6, wherein the avoiding duplicating the transaction comprises:
rejecting the incoming message as a duplicate based on the correlation identifier stored in the message-oriented middleware messaging system matching the correlation identifier of the incoming message; and
accepting the incoming message based on the correlation identifier stored in the message-oriented middleware messaging system not matching the correlation identifier of the incoming message.

8. The computer-implemented method of claim 4, wherein the reconciling the transaction comprises removing the message from the work-in-progress queue in the first data center and removing the replicated message from the work-in-progress queue in the second data center based on the correlation identifier.

9. A computer program product comprising one or more computer readable storage media having program instructions collectively stored on the one or more computer readable storage media, the program instructions executable to:
receive a message at a first data center, wherein the message includes a payload and is associated with a transaction;
create a correlation identifier for the message using an encryption process with the payload of the message;
replicate the message and the correlation identifier at a second data center, wherein the replicated message comprises a copy of the payload in a work-in-progress queue of the second data center; and
in response to a failure of the first data center and a processing of the transaction using the replicated message at the second data center, reconcile the transaction using the correlation identifier.

10. The computer program product of claim 9, wherein the encryption process comprises applying a tiger cryptographic iterated hashing algorithm to the payload.

11. The computer program product of claim 9, wherein:
the message is received at a gateway of the first data center;
the message is placed in a work-in-progress queue in the first data center; and
the gateway of the first data center, the work-in-progress queue in the first data center, and the work-in-progress queue of the second data center are comprised in a message-oriented middleware messaging system.

12. The computer program product of claim 11, wherein the program instructions are executable to store the correlation identifier in the message-oriented middleware messaging system.

13. The computer program product of claim 12, wherein the program instructions are executable to avoid duplicating the transaction by comparing the correlation identifier stored in the message-oriented middleware messaging system to a correlation identifier of an incoming message.

14. The computer program product of claim 13, wherein the avoiding duplicating the transaction comprises:
rejecting the incoming message as a duplicate based on the correlation identifier stored in the message-oriented middleware messaging system matching the correlation identifier of the incoming message; and
accepting the incoming message based on the correlation identifier stored in the message-oriented middleware messaging system not matching the correlation identifier of the incoming message.

15. A system comprising:
a processor set, one or more computer readable storage media, and program instructions collectively stored on the one or more computer readable storage media, the program instructions executable to:
receive a message at a first data center, wherein the message includes a payload and is associated with a transaction;
create a correlation identifier for the message using an encryption process with the payload of the message;
replicate the message and the correlation identifier at a second data center, wherein the replicated message comprises a copy of the payload in a work-in-progress queue of the second data center; and
in response to a failure of the first data center and a processing of the transaction using the replicated message at the second data center, reconcile the transaction using the correlation identifier.

16. The system of claim 15, wherein the encryption process comprises applying a tiger cryptographic iterated hashing algorithm to the payload.

17. The system of claim 15, wherein:
the message is received at a gateway of the first data center;
the message is placed in a work-in-progress queue in the first data center; and
the gateway of the first data center, the work-in-progress queue in the first data center, and the work-in-progress queue of the second data center are comprised in a message-oriented middleware messaging system.

18. The system of claim 17, wherein the program instructions are executable to store the correlation identifier in the message-oriented middleware messaging system.

19. The system of claim 18, wherein the program instructions are executable to avoid duplicating the transaction by comparing the correlation identifier stored in the message-oriented middleware messaging system to a correlation identifier of an incoming message.

20. The system of claim 19, wherein the avoiding duplicating the transaction comprises:
rejecting the incoming message as a duplicate based on the correlation identifier stored in the message-oriented middleware messaging system matching the correlation identifier of the incoming message; and
accepting the incoming message based on the correlation identifier stored in the message-oriented middleware messaging system not matching the correlation identifier of the incoming message.
